(19) United States
(12) Patent Application Publication
(10) Pub. No.: US 2022/0092235 A1
(43) Pub. Date: Mar. 24, 2022

(54) SIMULATED THERMAL VALUE MODIFICATIONS FOR 3D MODEL SECTIONS

(71) Applicant: Hewlett-Packard Development Company, L.P, Spring, TX (US)

(72) Inventors: Jacob Wright, San Diego, CA (US); Xin Cheng, Vancouver, WA (US); Matthew A. Shepherd, Vancouver, WA (US); Vanessa Verzwyvelt, Vancouver, WA (US)

(73) Assignee: Hewlett-Packard Development Company, L.P., Spring, TX (US)

(21) Appl. No.: 17/417,938

(22) PCT Filed: May 3, 2019
(86) PCT No.: PCT/US2019/030736

§ 371 Date: Jun. 24, 2021

(51) Int. Cl. G06F 30/20; B29C 64/386; B22F 10/80; B33Y 50/00; G06F 119/08

(52) U.S. Cl. CPC G06F 30/20; B29C 64/386; G06F 2119/08; B33Y 50/00; B22F 10/80

(57) ABSTRACT

According to examples, an apparatus may include a processor and a memory on which are stored machine-readable instructions that when executed by the processor, may cause the processor access a thermal simulation of a three-dimensional (3D) model, the thermal simulation identifying thermal values simulated to occur across the 3D model during fabrication of a 3D part corresponding to the 3D model. The instructions may also cause the processor to determine a modification to be applied to first thermal values corresponding to a first section of the 3D model, in which the modification may increase accuracy of the first thermal values in the thermal simulation and to apply the determined modification to the first thermal values to generate a modified thermal simulation of the 3D model.

### BACKGROUND

In three-dimensional (3D) printing, an additive printing process may be used to make three-dimensional solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat and/or a chemical binder.

### BRIEF DESCRIPTION OF THE DRAWINGS

Features of the present disclosure are illustrated by way of example and are not limited in the following figure(s), in which like numerals indicate like elements, in which:

FIG. 1 shows a block diagram of an example apparatus that may determine and apply a modification to first thermal values of a thermal simulation to generate a modified thermal simulation of a 3D model;

FIG. 2 shows a diagram of an example 3D fabrication system in which the apparatus depicted in FIG. 1 may be implemented;

FIG. 3 depicts an example diagram of a 3D model, a shifted 3D model, and a modified thermal simulation that may depict a first section of the 3D model for which thermal values may be modified;

FIG. 4 depicts a block diagram of an example apparatus that may determine and apply a modification to predicted thermal values of a first section of a 3D model;

FIG. 5 shows a flow diagram of an example method for improving an accuracy of predicted values of a first section of a 3D model; and

FIG. 6 shows a block diagram of an example computer readable medium that may have stored thereon machine readable instructions that when executed by a processor, may cause the processor to modify simulated thermal values of a first set of pixels of a 3D model.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Thermal simulations may be implemented to simulate or predict the thermal behavior of build material particles during the fabrication of three-dimensional (3D) parts using the particles. Some 3D fabrication systems may fabricate the 3D parts through selective application of coalescing or fusing agents and subsequently applying energy to fuse the particles upon which the agents have been deposited. In some instances, the simulated thermal behavior, e.g., the thermal values predicted to occur across a layer, may not accurately simulate the actual thermal behavior that may occur during fabrication of the 3D parts. For instance, the coalesced or fused sections of the 3D parts may shrink or deform in a manner that may cause, for instance, outer edges or sides of the fused sections to be higher (or lower) than the central areas of the fused sections. As a result, when a layer of particles is applied over the sections, the particles in an area above an edge, e.g., an edge of a section upon which the layer of particles first reaches as the layer is being spread, may be moved from their intended locations or additional particles may be moved to the area. For instance, some of the particles may move toward the center of the section or some of the particles may move toward the edge of the second. As a result, the density of the particles may differ from an intended density and thus, there may be a lower or higher density of particles at that area than intended.

As particles in areas with lower spread densities may absorb additional energy than intended due to increased penetration of the energy into those particles, those particles may become hotter than predicted during fabrication of a 3D part. This may result in overheating and overmelting along a side of the 3D part. In addition, particles in areas with higher spread densities may absorb less energy than intended to due, for instance, the increase number of particles that may absorb the energy, those particles may be cooler than predicted during fabrication of the 3D part. A thermal simulation of the 3D part may not accurately predict the temperatures of the particles in the area above a leading edge, or other location, of a 3D part, and may thus fail to predict the overheating or under heating along the side of a fused section. As thermal simulations may be used to determine, for instance, compositions at which agents are to be applied during fabrication, incorrect thermal simulations may result in a 3D part that is fabricated inaccurately and/or with reduced quality. For instance, incorrect thermal simulations may result in a 3D part that has sides that are inconsistent optically and/or mechanically with respect to each other.

Disclosed herein are apparatuses, methods, and computer readable media that may improve the accuracy of predicted values of sections of a 3D model through identification of a first section of the 3D model and modification of thermal values predicted for the first section. In some examples, the first section may correspond to a leading edge of the 3D model with respect to a direction in which a spreader may spread build material particles to form layers of particles. As such, for instance, in 3D printers that may spread the particles bi-directionally, the 3D model may have two leading edges. In addition, or in other examples, the first section may correspond to other sections of the 3D model. For instance, the first section may correspond to a side or other surface of a 3D part that may be identified to become hotter than predicted through thermal simulations. As such, for instance, the accuracies of predicted values of multiple sections of a 3D model may be improved.

According to examples, a processor may identify the first section through application of a shifting operation on an input image that includes the 3D model. Particularly, for instance, the processor may implement a convolution between an asymmetric kernel and the input image to generate an output image that includes a shifted 3D model. As an asymmetric kernel may be applied to the input image, the output image corresponding to the input image may include a shift in the position and/or shape of the 3D model. The first section of the 3D model may be identified through application of a mask on the shifted 3D model and/or a determination of a difference between the 3D model and the shifted 3D model.

The processor may determine a modification to be applied to first thermal values corresponding to the identified first section, for instance, to compensate for the likelihood that the particle density at the identified first section may differ from the predicted thermal values. The modification may be to increase or decrease the thermal values predicted to occur at the identified first section to more accurate thermal values. The level of modification, e.g., the level of temperature increase or the level of temperature decrease, may be based on modifications determined through testing, modeling, historical data, and/or the like, of various combinations of build material particles, agents, fabrication processes, and/or the like.

The processor may also apply the modification to the thermal values associated with the first section. In addition, the processor may not apply a modification to the thermal values associated with other sections of the 3D part. In this regard, the thermal values associated with the first section may obtain a thermal boost or a thermal reduction, while the thermal values associated with the other sections may remain as predicted in a modified thermal simulation. The processor may further generate an agent formulation map using the modified thermal values of the first section and the thermal values predicted for the other sections. Thus, for instance, the processor may determine from the modified thermal values that a lesser amount of an agent may be applied to the first section to prevent overheating at the first section. As the modified thermal simulation may more accurately predict the thermal values, the agent formulation map may be generated to control fabrication of the 3D part to more accurately correspond to the 3D model and to also have sides that are more consistent with each other optically and/or mechanically.

In some examples, the processor may communicate the agent formulation map to a print controller of a 3D fabrication system and the print controller may control components of the 3D fabrication system to implement the agent formulation map in fabricating the 3D part.

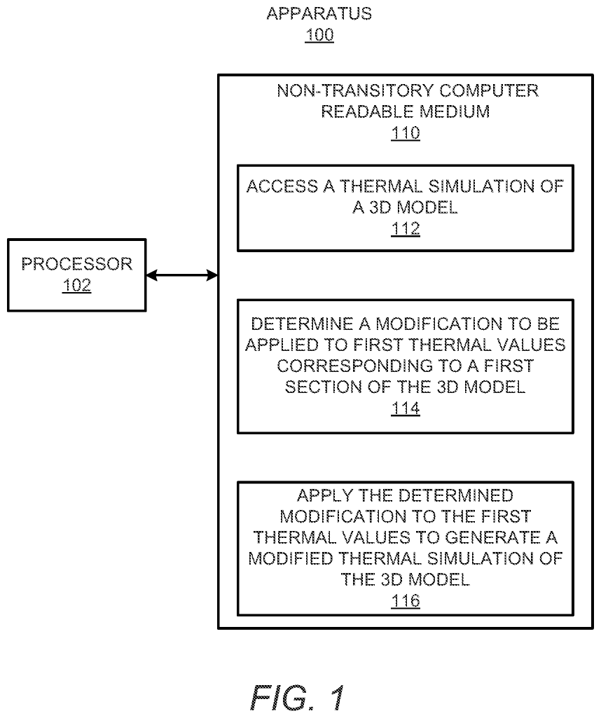

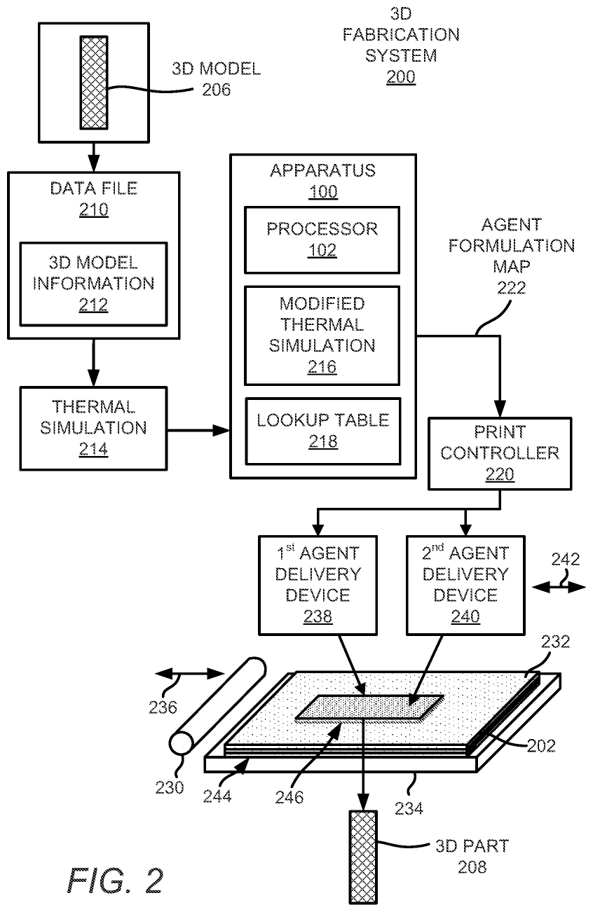

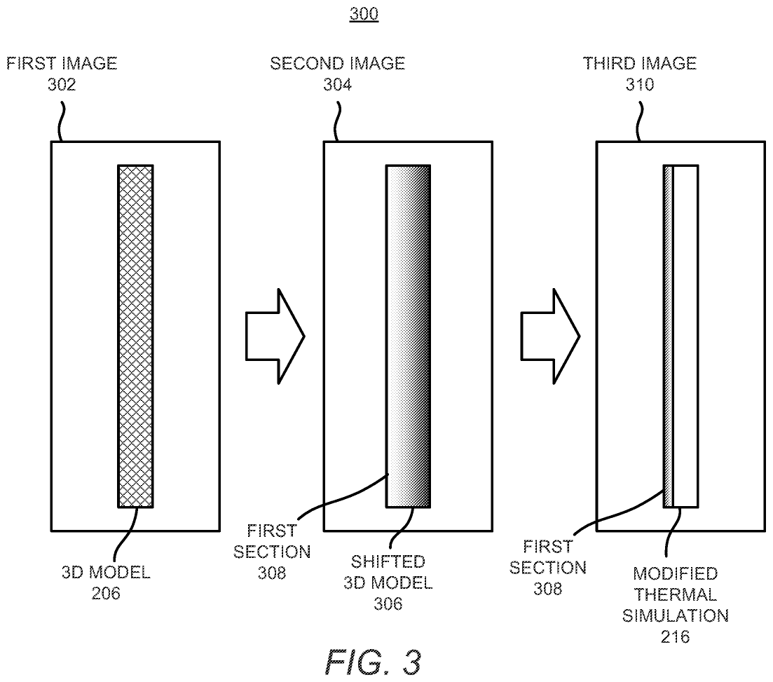

Reference is made first to FIGS. 1-3. FIG. 1 shows a block diagram of an example apparatus 100 that may determine and apply a modification to first thermal values of a thermal simulation to generate a modified thermal simulation of a 3D model. The modified thermal simulation may more accurately simulate thermal values of the 3D model that may be predicted to occur during fabrication of a 3D part corresponding to the 3D model. As such, for instance, the apparatus 100 may generate an agent formulation map that more accurately identifies volumes of agents that are to be deposited based on the modified thermal simulation of the 3D model. FIG. 2 shows a diagram of an example 3D fabrication system 200 in which the apparatus 100 depicted in FIG. 1 may be implemented. FIG. 3 depicts an example diagram 300 of a 3D model, a shifted 3D model, and a modified thermal simulation that may depict a first section of the 3D model for which thermal values may be modified.

It should be understood that the example apparatus 100 depicted in FIG. 1, the example 3D fabrication system 200 depicted in FIG. 2, and the example diagram 300 may include additional features and that some of the features described herein may be removed and/or modified without departing from the scopes of the apparatus 100, the 3D fabrication system 200, or the diagram 300.

The apparatus 100 may be a computing device, a tablet computer, a server computer, a smartphone, or the like. The apparatus 100 may alternatively be part of the 3D fabrication system 200, e.g., a CPU of the 3D fabrication system 200. Although the apparatus 100 is depicted as including a single processor 102, it should be understood that the apparatus 100 may include multiple processors, multiple cores, or the like, without departing from a scope of the apparatus 100.

The 3D fabrication system 200, which may also be termed a 3D printing system, a 3D fabricator, or the like, may be implemented to fabricate or equivalently, print, 3D parts through selective solidification of build material particles 202, which may also be termed particles 202 of build material. In some examples, and as discussed herein, the 3D fabrication system 200 may use agents to selectively bind and/or solidify the particles 202. In particular examples, the 3D fabrication system 200 may use agents that increase the absorption of fusing energy to selectively fuse the particles 202 on which the agents are deposited. In addition, the 3D fabrication system 200 may use colorant agents to apply color to sections of 3D parts. The colorants, or colorant agents, may be differently colored inks, such as inks having one of cyan, magenta, yellow, or black colors, although the 3D fabrication system 200 may use additional or other colored inks. In some examples, fusing agents and colorants may be combined into colored fusing agents, while in other examples, the fusing agents may be separate from the colorants. In any of these examples, some of the fusing agents may be mainly transparent, e.g., have a low tint, while other fusing agents may have a dark, e.g., black color. Although particular reference is made herein to colorant agents, the agents may also or alternatively include agents that may cause other modifications to the particles 202, such as translucency, elasticity, electrical conductivity, and/or the like, modifications.

According to one example, a suitable agent may be an ink-type formulation including carbon black, such as, for example, the agent formulation commercially known as V1Q60A “HP fusing agent” available from HP Inc. The carbon black agent may be used to fuse particles that form interiors, e.g., hidden core portions, of 3D parts, while agents having lighter colors and/or greater translucency may be used to fuse particles that form exteriors of the 3D parts. In one example, such an agent may additionally include an infra-red light absorber. In one example such agent may additionally include a near infra-red light absorber. In one example, such an agent may additionally include a visible light absorber. In one example, such an agent may additionally include a UV light absorber. Examples of agents including visible light enhancers are dye based colored ink and pigment based colored ink, such as inks commercially known as CE039A and CE042A available from HP Inc.

According to examples, the 3D fabrication system 200 may use a fusing agent that may be separate from the colorant agents. As discussed herein, the fusing agent may have a dark color or may have a light, low tint color. In these examples, the 3D fabrication system 200 may separately control the volumes at which the fusing agent and the colorant agents may be applied onto the build material particles 202. According to examples, the 3D fabrication system 200 may additionally use a detailing agent that may reduce or impede coalescence, e.g., fusing, of build material particles 202 onto which the agent has been deposited and/or absorbed. In one example, the detailing agent may be a substantially transparent liquid. According to one example, a suitable type of such an agent may be a formulation commercially known as V1Q61A “HP detailing agent” available from HP Inc. The 3D fabrication system 200 may also separately control the volumes at which the detailing agent is applied.

The build material particles 202 may include any suitable material for use in forming 3D objects. The build material particles 202 may include, for instance, a polymer, a plastic, a ceramic, a nylon, a metal, combinations thereof, or the like, and may be in the form of a powder or a powder-like material. Additionally, the build material particles 202 may be formed to have dimensions, e.g., widths, diameters, or the like, that are generally between about 5 μm and about 100 μm. In other examples, the particles 202 may have dimensions that are generally between about 30 μm and about 60 μm. The particles 202 may have any of multiple shapes, for instance, as a result of larger particles being ground into smaller particles. In some examples, the particles 202 may be formed from, or may include, short fibers that may, for example, have been cut into short lengths from long strands or threads of material. In addition or in other examples, the particles 202 may be partially transparent or opaque. According to one example, a suitable build material may be PA12 build material commercially known as V1R10A “HP PA12” available from HP Inc.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. The apparatus 100 may also include a non-transitory computer readable medium 110 that may have stored thereon machine readable instructions 112-116 (which may also be termed computer readable instructions) that the processor 102 may execute. The non-transitory computer readable medium 110 may be an electronic, magnetic, optical, or other physical storage device that includes or stores executable instructions, where the term “non-transitory” does not encompass transitory propagating signals. The non-transitory computer readable medium 110 may be, for example, Random Access memory (RAM), an Electrically Erasable Programmable Read-Only Memory (EEPROM), a storage device, an optical disc, and the like. The non-transitory computer readable medium 110 may also be referred to as a memory.

In some examples, instead of the non-transitory computer readable medium 110, the apparatus 100 may include hardware logic blocks that may perform functions similar to the instructions 112-116. In yet other examples, the apparatus 100 may include a combination of instructions and hardware logic blocks to implement or execute functions corresponding to the instructions 112-116. In any of these examples, the processor 102 may implement the hardware logic blocks and/or execute the instructions 112-116. As discussed herein, the apparatus 100 may also include additional instructions and/or hardware logic blocks such that the processor 102 may execute operations in addition to or in place of those discussed above with respect to FIG. 1.

As discussed herein, a 3D model 206 may be a data representation of a 3D part 208 to be fabricated. Particularly, for instance, a data file 210 may include 3D model information 212 about the 3D model 206 that the processor 102 may access to determine printing parameters, e.g., layer identifications, layer region thicknesses, agent formulations, and/or the like, to be used in fabricating a 3D part 208. For instance, the data file 210 may include information pertaining to features of the 3D model 206, such as physical dimensions, orientation information of surfaces, color information, etc., of the 3D model 206.

The processor 102 may fetch, decode, and execute the instructions 112 to access a thermal simulation 214 of the 3D model. The thermal simulation 214 may identify thermal values simulated or predicted to occur across the 3D model 206 during fabrication of a 3D part 208 corresponding to the 3D model 206. In some examples, the processor 102 may access thermal simulations of slices of the 3D model 206. For instance, the 3D model 206 depicted in FIGS. 2 and 3 may represent a slice of a 3D model 206. The slices of the 3D model 206 may respectively correspond, for instance, to layers 232 of build material particles 202 that may be formed into the 3D part 208.

As discussed herein, agents such as coalescing, fusing, colorant, combinations thereof, and/or the like, may be applied onto selected locations of the layers 232 of build material particles 202 that are to be coalesced, fused, or the like to form sections of the 3D part 208 in the layers 232. Energy may be applied to the layers 232 to cause the particles 202 upon which the agents have been applied to melt and to subsequently solidify together during cooling of the particles 202. The thermal simulation 214 for a slice of the 3D model 206 may identify thermal values, e.g., temperature values, heat values, and/or the like, across the slice that are predicted to occur during or after application of the energy onto the slice. The thermal simulation 214 may also be referenced as a heat map.

Generally speaking, the thermal values at respective locations of the slice may vary depending upon various factors such as the type of agent applied, the color of the agent applied, the volume of the agent applied, the amount of energy applied, whether the agent is a fusing agent, whether the agent is a detailing agent, the volume and type of agent applied on a number of lower slices, and/or the like. Additionally, in some instances, the predicted thermal values fora particular section of the 3D model 206 in the thermal simulation 214 may not accurately reflect the actual thermal conditions that may occur along that section during fabrication of the 3D part 208.

In some examples, the processor 102 may determine the thermal simulation 214 of the 3D model 206, for instance, through application of a modeling process that may use historical data, and/or the like. In these examples, the processor 102 may access the thermal simulation 214 through generation of the thermal simulation 214 of the 3D model. In other examples, the thermal simulation 214 may have been determined by another device (not shown) and the processor 102 may access the thermal simulation 214 from the other device. In any of these examples, the thermal simulation 214 may be generated on a per layer basis such that the simulated thermal values for one layer 232 may be used as part of the input in the thermal simulation 214 for a next and/or a further layer 232. In one regard, therefore, the thermal simulations 214 for the layers may be determined as continuous simulations that may take into consideration the modified thermal values associated with sections of previous layers 232.

As discussed herein, the thermal conditions predicted to occur at the particular section, e.g., a particular side of the 3D model 206, may not accurately correspond to the actual thermal characteristics of the 3D part 208 during fabrication of the 3D part 208. Instead, the temperatures at the particular section of the 3D model 206 may become higher than predicted. This may occur because sections of the 3D part 208 that have been fused together in previously formed layers may experience some amount of shrinkage or other unintended deformation. The base upon which particles 202 in a current layer may be deposited may not be even, which may cause some of the particles 202 to be moved from their intended locations. For instance, the fused sections in the previously formed layers may experience a meniscus effect in which the central portion of the fused sections may be lower than the sides (or outer edges) of the fused sections. This effect may cause the spread density of the particles 202 along a particular side, e.g., a side that is closest to the origin side of a particle spread direction, to be lower than intended.

As particles 202 in areas with lower spread densities may absorb additional energy than intended due to increased penetration of the energy, those particles 202 may become hotter than predicted. According to examples, as discussed herein, the section of the 3D model 206, e.g., a leading edge of the 3D model 206 with respect to a direction in which the particles 202 are spread to form a layer, that may become hotter than predicted may be identified and the thermal values associated with the particles 202 in the identified section may be modified.

As another example, the fused sections in the previously formed layers may experience a bowing effect in which the central portion of the fused sections may be higher than the sides (or outer edges) of the fused sections. This effect may cause the spread density of the particles 202 along a particular side, e.g., a side that is closest to the origin side of the particle spread direction, to be higher than intended. As particles 202 in areas with higher spread densities may absorb less energy than intended due to increased number of particles to absorb the energy, those particles 202 may become cooler than predicted. According to examples, as discussed herein, the section of the 3D model 206, e.g., a leading edge of the 3D model 206 with respect to a direction in which the particles 202 are spread to form a layer, that may become cooler than predicted may be identified and the thermal values associated with the particles 202 in the identified section may be modified.

The processor 102 may fetch, decode, and execute the instructions 114 to determine a modification to be applied to first thermal values corresponding to a first section of the 3D model 206, in which the modification may increase accuracy of the first thermal values in the thermal simulation 214. As discussed herein, the first section of the 3D model 206 may correspond to a first side of the 3D model 206 or to a first side of a slice of the 3D model 206. That is, for instance, the first section of the 3D model 206 may correspond to a side of the 3D model 206 that may experience a greater level of heating than predicted or a lesser level of heating than predicted. According to examples, the processor 102 may apply a filter to select a size of the first section that is to receive the modification.

The processor 102 may identify the first section of the 3D model 206 through implementation of a processing operation on an image of the 3D model 206. An example processing operation is depicted in the diagram 300 depicted in FIG. 3. As shown in FIG. 3, the processor 102 may access, for instance, from the data file 210, a first image 302 that may include the 3D model 206. The processor 102 may generate a second image 304 based on the first image 302, in which the second image 304 may be a shifted version of the first image 302 and may include a shifted version of the 3D model 306. The processor 102 may generate the second image 304 through application of a shifting operation on the first image 302 to generate the second image 304. The shifting operation may include implementation of a convolution between a kernel and the first image 302 to generate the second image 304.

According to examples, the processor 102 may apply an asymmetric kernel to the first image 302 to generate the second image 304. The first image 302 and the second image 304 may each be two dimensional images of a cross-section of the 3D model 206. The asymmetric kernel may be a one dimensional matrix that may have values that are asymmetric and may be applied along either the rows or the columns of the first image 302 depending on which side of the 3D model 206 is to be identified. Examples of a one dimensional three pixel kernel including a symmetric matrix may include any of the following sets of values: (1,1,1), (1,0,1), or (0,1,0). In contrast, an example of a one dimensional 3 pixel kernel including an asymmetric matrix may include the following set of values: (0,0,1). As the one dimensional kernel is asymmetric, application of the one dimensional kernel on the first image 302 may cause the image data in the first image 302 to be positionally shifted, e.g., as shown in the second image 304. For instance, application of the example asymmetric kernel noted above may shift the data in the first image 302 (e.g., the input image) one pixel to the right when applied along the first image 302.

It should be understood that the present disclosure is not limited to any particular set of values in an asymmetric kernel. Instead, the asymmetric kernel discussed herein may have any number of values and may be any of a Gaussian kernel, a straight ramp kernel, a square function kernel, or the like. The asymmetric kernel may also be a one dimensional kernel or a two dimensional kernel. In some examples, a first one dimensional kernel may be applied to rows of image data and another one dimensional kernel may be applied to columns of image data to identify, for instance, both a side and top or bottom of the 3D model 206.

In some examples, the asymmetric kernel discussed herein may be a gradiented kernel, such as a sigmoid, linearly tapering, or the like, kernel. The use of a gradiented kernel may allow for control over the taper of a modification (or equivalently, a compensation) applied to the thermal values in the first section of the 3D model 206. That is, the use of a gradiented kernel may prevent a hard transition between thermal values that are modified and thermal values that are not modified. An example gradiented kernel is provided below with a shifted normal distribution and a sum of 1024, e.g., the contribution of an input pixel to an output pixel, may be the value in the kernel over the sum of kernel values. 0, 1, 1, 2, 4, 6, 8, 12, 17, 24, 32, 42, 53, 65, 78, 90, 102, 113, 121, 126, 127

As shown in the second image 304, the shifted 3D model 306, which may represent a particular cross section, e.g., slice, of the 3D model 206, may include differences from the 3D model 206 included in the first image 302. That is, for instance, by shifting the 3D model 206 to the left or the right, there may be a section of the 3D model 206 that is included in the first image 302 but not in the second image 304. Likewise, there may be a section of the shifted 3D model 306 that is included in the second image 304 but not in the first image 302. There may also be a section that may be included both the first image 302 and the second image 304. These various sections are depicted as having different shading values in the second image 304.

The processor 102 may mask the second image 304 with either 3D model data or NOT 3D model data to isolate the left hand sides and the right hand sides of the shifted 3D model 306. In addition or alternatively, the processor 102 may compare the shifted 3D model 306 with the 3D model 206 to identify the differences and may identify the first section 308 from the comparison. That is, for instance, the processor 102 may determine a difference between the shape of the 3D model 206 included in the first image 302 (input image 302) and the shape of the shifted 3D model 306 included in the second image 304 (output image 304). The processor 102 may identify the first section 308 of the 3D model 306 based on the determined difference.

The processor 102 may fetch, decode, and execute the instructions 116 to apply the determined modification to the first thermal values to generate a modified thermal simulation 216 of the 3D model. According to examples, the processor 102 may apply a modification to the thermal values predicted to occur for the first section 308 as defined in the thermal simulation 214. For instance, the processor 102 may apply a temperature boost, e.g., raise the predicted thermal values for the first section 308. In some examples, the amount of temperature boost applied to the predicted thermal values may be tapered according to distances of pixels in the first section 308 from an edge of the 3D model 206. That is, for instance, the pixels closest to the edge may get a larger boost than the pixels in the first section 308 that are farther from the edge to gradually decrease the temperature boost as pixels in the first edge get closer to the pixels that are not modified to receive the temperature boost. By way of particular example, the temperature boost may be a temperature that may range between about 1° C. and about 7° C., although other temperatures may be used. The temperature boost value may be or may have been determined through testing, modeling, historical data, and/or the like. In other example, the modification may be temperature decrease, which may be applied in manners similar to those discussed above with respect to the temperature boost.

In some examples, the modifications, e.g., temperature boosts or temperature reductions, to be applied to the first section 308 may be stored in a lookup table 218, which the processor 102 may access to determine the level of modification to be applied to the pixels in the first section 308. The lookup table 218 may include correlations between the distances of the pixels and the amounts of modifications to be applied, for instance, in order to improve accuracy of the predicted thermal values, which may result in a more accurate fabrication of the 3D part 208. According to examples, various correlations between the amounts of modifications to be applied and the distances that may result in the improved accuracy as discussed herein may be or may have been determined through testing, modeling, historical data, and/or the like, of various combinations of build material particles 202, agents, fabrication processes, and/or the like.

Through application of the modified thermal values in the first section 308, the processor 102 may generate a modified thermal simulation 216 as may be included in a third image 310, in which the thermal values corresponding to the first section 308 may more accurately reflect the actual thermal values that may be predicted to occur during fabrication of the 3D part 208. In some examples, the processor 102 may repeat the process depicted in FIG. 3 for each or a plurality of slices of the 3D part 208 and may determine modified thermal simulations 216 for those additional slices of the 3D part 208.

Based on the modified thermal simulation 216, the processor 102 may determine an agent formulation map 222 to be implemented during fabrication of the 3D part 208. As discussed herein, the agent formulation map 222 may define the locations and amounts, e.g., volumes, drop numbers, etc., at which an agent is or multiple agents are to be applied onto respective layers 232 of build material particles 202 to fabricate the 3D part 208. The agent or agents may include an agent that may modify the build material particles 202 on which the agent is deposited and/or absorbed. The modification may be a mechanical, chemical, physical, or the like, modification to the build material particles. For instance, the agent may cause the build material particles to melt (after application of energy onto the build material particles), coalesce, bind, fuse, or the like. In addition, or alternatively, the agent may apply an optical property to the build material particles, such as, color, transparency, opacity, or the like. Thus, for instance the determined agent formulation map 222 may include a formulation of multiple agents that may modify a color and physical property of the build material particles.

According to examples, the processor 102 may determine the locations and amounts of agent(s) that are to be applied based on the thermal values identified in the modified thermal simulation 216. For instance, the processor 102 may determine that a first location of a layer of particles 202 is to receive a relatively smaller volume of fusing agent than a second location on the layer if the predicted thermal value of the first location is higher than a threshold temperature and the predicted thermal value of the second location is at or below the threshold temperature. Alternatively, the processor 102 may determine that the first location of the layer of particles 202 is to receive a relatively larger volume of fusing agent than the second location on the layer if the predicted thermal value of the first location is lower than a second threshold temperature and the predicted thermal value of the second location is at or above the second threshold temperature.

The processor 102 may create the agent formulation map 222 to define the agent formulations for each layer of the 3D part 208. As shown in FIG. 2, the processor 102 may also communicate the agent formulation map 222 to a print controller 220 of the 3D fabrication system 200. The print controller 220 may control operations of components of the 3D fabrication system 200 to fabricate the 3D part 208. For instance, the print controller 220 may control operations of the components to fabricate the 3D part 208 according to the received agent formulation map 222.

The 3D fabrication system 200 may include a spreader 230 that the print controller 220 may control to spread the build material particles 202 into a layer 232, e.g., through movement across a platform 234 as indicated by the arrow 236. The spreader 230 may spread the particles across one direction or across both directions denoted by the arrow 236. As also shown in FIG. 2, the 3D fabrication system 200 may include a first agent delivery device 238 and a second agent delivery device 240, although additional agent delivery devices may also be included. The first agent delivery device 238 and the second agent delivery device 240 may be scanned in the direction denoted by the arrow 242, in a direction perpendicular to the arrow 242, and/or in other directions. In addition, or alternatively, the platform 234 on which the layers 232 are deposited may be scanned in directions with respect to the first agent delivery device 238 and the second agent delivery device 240. Although not shown, the 3D fabrication system 200 may include an energy source that may output energy onto the layer 232 as the energy source is scanned across the layer 232 as denoted by the arrow 242. The energy source may be a laser beam source, a heating lamp, or the like, that may apply energy onto the layer 232 and/or that may apply energy onto the selected area 244.

The 3D fabrication system 200 may include a build zone 244 within which the components of the 3D fabrication system 200 may solidify the build material particles 202 in a selected area 246 of the layer 232. The selected area 246 of a layer 232 may correspond to a section of the 3D part 208 being fabricated in multiple layers 232 of the build material particles 202. The 3D fabrication system 200 may fabricate the 3D printed part 208 through selective deposition of a first agent and a second agent on respective layers 232 of the build material particles 202. The first agent may be an agent that is to modify a mechanical property of the build material particles 202 and the second agent may be an agent that is to modify an optical property of the build material particles 202. Although not shown, the 3D fabrication system 200 may include an additional agent delivery device that may deliver a similar type of agent, another type of agent, or the combinations thereof. Thus, for instance, the print controller 220 may control the agent delivery devices 238, 240 to selectively deposit the first agent, multiple second agents, and in some instances, a third agent (e.g., a detailing agent), onto respective layers 232 according to the determined agent formulations to fabricate the 3D printed part 208.

A first type of agent, such as a coalescing or fusing agent, may enhance absorption of energy to cause the build material particles 202 upon which the agent has been deposited to melt. The first type of agent may be applied to the build material particles 202 prior to application of energy onto the build material particles 202.

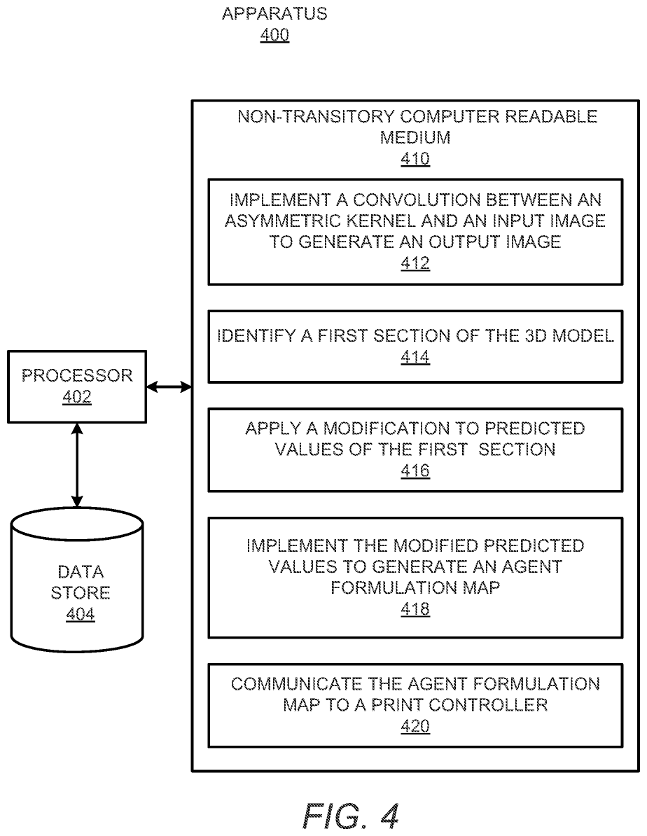

Turning now to FIG. 4, there is shown a block diagram of an example apparatus 400 that may determine and apply a modification to predicted thermal values of a first section 308 of a 3D model 206. It should be understood that the example apparatus 400 depicted in FIG. 4 may include additional features and that some of the features described herein may be removed and/or modified without departing from the scope of the apparatus 400. The description of the apparatus 400 is made with respect to the 3D fabrication system 200 shown in FIG. 2 and the diagram 300 depicted in FIG. 3.

The apparatus 400 may be equivalent to the apparatus 100 depicted in FIG. 1. As shown in FIG. 4, the apparatus 400 may include a processor 402 that may control operations of the apparatus 400 and a non-transitory computer readable medium 410 that may have stored thereon machine readable instructions 412-420 (which may also be termed computer readable instructions) that the processor 402 may execute. The processor 402 and the non-transitory computer readable medium 410 may be similar to the processor 102 and the non-transitory computer readable medium 110 depicted in FIG. 1.

The processor 402 may fetch, decode, and execute the instructions 412 to implement a convolution between an asymmetric kernel and an input image 302 to generate an output image 304. Through implementation of the convolution, the output image 302 may include a shift in a shape of the 3D model 206 included in the input image 302. The processor 402 may implement the convolution as discussed herein.

The processor 402 may fetch, decode, and execute the instructions 414 to identify a first section 308 of the 3D model 206 based on the shape of the 3D model 206 included in the input image 302 and the shape of the 3D model included in the output image 304. The processor 402 may identify the first section 308 through any of the mapping and/or comparison processes discussed herein.

The processor 402 may fetch, decode, and execute the instructions 416 to apply a modification to predicted values of the first section 308. As discussed herein, the modification may be applied to improve accuracy of the predicted values of the first section 308, which may also improve the accuracy of the predicted values of other sections of the 3D model 206. The modification may be applied only to the first section 308 without being applied to the other sections of the 3D model 206.

The processor 402 may fetch, decode, and execute the instructions 418 to implement the modified predicted values of the first section 308 to generate an agent formulation map 222 for the 3D model 206. The processor 402 may store the modified predicted values as well as the generated agent formulation map 222 in a data store 404. In addition, the processor 402 may fetch, decode, and execute the instructions 420 to communicate the agent formulation map 222 to the print controller 220, which may use the agent formulation map 22 to fabricate the 3D part 208.

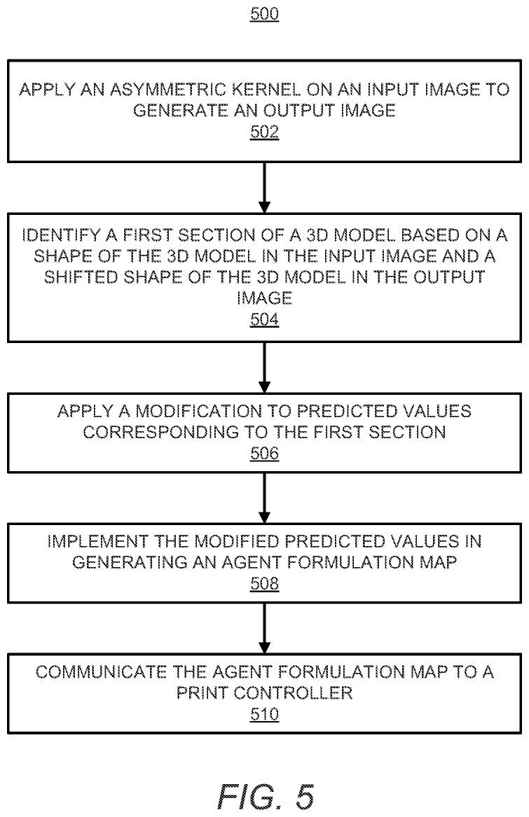

Various manners in which the processor 102, 402 may operate are discussed in greater detail with respect to the method 500 depicted in FIG. 5. Particularly, FIG. 5 depicts a flow diagram of an example method 500 for improving an accuracy of predicted values of a first section 308 of a 3D model 206. It should be understood that the method 500 depicted in FIG. 5 may include additional operations and that some of the operations described therein may be removed and/or modified without departing from the scope of the method 500. The description of the method 500 is made with reference to the features depicted in FIGS. 1-4 for purposes of illustration.

At block 502, the processor 102, 402 may apply an asymmetric kernel on an input image 302 to generate an output image 304, the output image 304 including a shift in a shape of a 3D model 206 included in the input image 302. The processor 102, 402 may apply the asymmetric kernel, e.g., implement a convolution of the asymmetric kernel and the input image 302, as discussed herein.

At block 504, the processor 102, 402 may identify a first section 308 of the 3D model 206 based on a shape of the 3D model 206 in the input image 302 and a shifted shape of the 3D model 306 in the output image 304. The processor 102, 402 may identify the first section 308 of the 3D model 206, e.g., a particular side of the 3D model 206, in any of the manners discussed above.

At block 506, the processor 102, 402 may apply a modification to predicted values, e.g., predicted thermal values, corresponding to the first section 308, in which the modification is to improve accuracy of the predicted values. For instance, the processor 102, 402 may increase the predicted temperatures of the pixels in the first section 308 above nominally predicted temperatures. The predicted thermal values may be fixed for the pixels or may be linearly varying based on distances between the pixels and an edge, or other reference location, of the 3D model 206.

At block 508, the processor 102, 402 may implement the modified predicted values in generating an agent formulation map 222. That is, the processor 102, 402 may generate the agent formulation map 222 based on the modified predicted values for the first section 308 along with the predicted values for the remaining sections of the 3D model 206. As discussed herein, the processor 102, 402 may generate the agent formulation map 222 to specify agent formulations, including volumes and locations of agent droplets, on respective layers of build material particles 202 to fabricate the 3D part 208 to accurately correspond to the 3D model 206.

At block 510, the processor 102, 402 may communicate the agent formulation map 222 to the print controller 220. The print controller 220 may fabricate the 3D part 208 in multiple layers 232 of particles 202 based on the agent formulation map 222.

Some or all of the operations set forth in the method 500 may be included as utilities, programs, or subprograms, in any desired computer accessible medium. In addition, the method 500 may be embodied by computer programs, which may exist in a variety of forms. For example, the method 500 may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

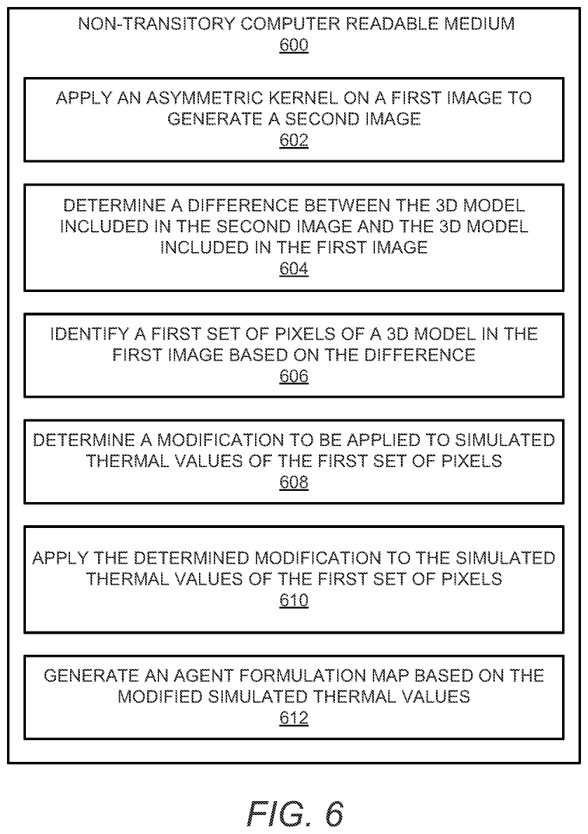

Turning now to FIG. 6, there is shown a block diagram of an example computer readable medium 600 that may have stored thereon machine readable instructions that when executed by a processor, may cause the processor to modify simulated thermal values of a first set of pixels of a 3D model 206. It should be understood that the computer readable medium 600 depicted in FIG. 6 may include additional instructions and that some of the instructions described herein may be removed and/or modified without departing from the scope of the computer readable medium 600 disclosed herein. The computer readable medium 600 may be a non-transitory computer readable medium. The term “non-transitory” does not encompass transitory propagating signals.

The computer readable medium 600 may have stored thereon machine readable instructions 602-612 that a processor, such as the processor 102, 402 depicted in FIGS. 1 and 4, may execute. The computer readable medium 600 may be an electronic, magnetic, optical, or other physical storage device that includes or stores executable instructions. The computer readable medium 600 may be, for example, Random Access memory (RAM), an Electrically Erasable Programmable Read-Only Memory (EEPROM), a storage device, an optical disc, and the like.

The processor may fetch, decode, and execute the instructions 602 to apply an asymmetric kernel on a first image 302 to generate a second image 304, the second image including a shifted version of the first image 302. The processor may fetch, decode, and execute the instructions 604 to determine a difference between the 3D model 206 included in the second image 304 and the 3D model 206 included in the first image 302. The processor may fetch, decode, and execute the instructions 606 to identify a first set of pixels of the 3D model 206 based on the determined difference. The first set of pixels may correspond to the pixels in a first section 308 of the 3D model 206.

The processor may fetch, decode, and execute the instructions 608 to determine a modification to be applied to simulated thermal values of the first set of pixels, in which the modification may cause the simulated thermal values to more accurately reflect actual thermal values of a 3D part 208 corresponding to the 3D model 206 during fabrication of the 3D part 208. The processor may fetch, decode, and execute the instructions 610 to apply the determined modification to the simulated thermal values of the first set of pixels. The processor may fetch, decode, and execute the instructions 612 to generate an agent formulation map 222 to be implemented during fabrication of the 3D part 208 based on the modified simulated thermal values corresponding to the first set of pixels.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, are to cause the processor to:
access a thermal simulation of a three-dimensional (3D) model, the thermal simulation identifying thermal values simulated to occur across the 3D model during fabrication of a 3D part corresponding to the 3D model;
determine a modification to be applied to first thermal values corresponding to a first section of the 3D model, wherein the modification is to increase accuracy of the first thermal values in the thermal simulation; and
apply the determined modification to the first thermal values to generate a modified thermal simulation of the 3D model.

2. The apparatus of claim 1, wherein the instructions are further to cause the processor to:
generate, based on the modified thermal simulation of the 3D model, an agent formulation map to be implemented during fabrication of the 3D part.

3. The apparatus of claim 1, wherein the instructions are further to cause the processor to:
generate a second image based on a first image of the 3D model, the second image being a shifted version of the first image and including the 3D model;
compare the 3D model in the second image with the 3D model in the first image; and
identify the first section based on the comparison.

4. The apparatus of claim 3, wherein the instructions are further to cause the processor to:
apply a shifting operation on the first image to generate the second image.

5. The apparatus of claim 3, wherein the instructions are further to cause the processor to:
apply an asymmetric kernel to the first image to generate the second image.

6. The apparatus of claim 1, wherein the instructions are further to cause the processor to:
determine modifications to be applied to the first thermal values, wherein the modifications are tapered according to distances of pixels in the first section from an edge of the 3D model, and wherein the modifications are temperature boosts or temperature decreases to the first thermal values.

7. The apparatus of claim 6, wherein the instructions are further to cause the processor to:
identify the first section of the 3D model, wherein the first section is a side of the 3D model; and
determine the modification from a lookup table that identifies correlations between the modifications and the distances of the pixels from an edge of the 3D model.

8. A method comprising:
applying, by a processor, an asymmetric kernel on an input image to generate an output image, the output image comprising a shift in a shape of a three-dimensional (3D) model included in the input image, wherein a 3D part corresponding to the 3D model is to be fabricated through a 3D fabrication process;
identifying, by the processor, a first section of the 3D model based on a shape of the 3D model in the input image and a shifted shape of the 3D model in the output image; and
applying, by the processor, a modification to predicted values corresponding to the first section, wherein the modification is to improve accuracy of the predicted values.

9. The method of claim 8, wherein applying the modification further comprises applying the modification to the predicted values corresponding to the first section of the 3D model without applying the modification to other sections of the 3D model.

10. The method of claim 8, further comprising:
implementing the modified predicted values corresponding to the first section in generating an agent formulation map to be implemented during fabrication of the 3D part.

11. The method of claim 8, further comprising:
determining a difference between the shape of the 3D model included in the input image and the shifted shape of the 3D model in the output image; and
identifying the first section based on the determined difference.

12. The method of claim 8, wherein the predicted values comprise thermal values predicted to occur at locations corresponding to the first section during fabrication of the 3D part and wherein the modification comprises a predetermined thermal increase to the predicted values.

13. A non-transitory computer readable medium on which is stored machine readable instructions that when executed by a processor, cause the processor to:
identify a first set of pixels of a three-dimensional (3D) model in a first image;
determine a modification to be applied to simulated thermal values of the first set of pixels, the modification to cause the simulated thermal values to more accurately reflect actual thermal values of a 3D part corresponding to the 3D model during fabrication of the 3D part; and
apply the determined modification to the simulated thermal values of the first set of pixels.

14. The non-transitory computer readable medium of claim 13, wherein the instructions are further to cause the processor to:
generate an agent formulation map to be implemented during fabrication of the 3D part based on the modified simulated thermal values corresponding to the first set of pixels.

15. The non-transitory computer readable medium of claim 13, wherein the instructions are further to cause the processor to:
apply an asymmetric kernel on the first image to generate a second image, the second image comprising a shifted version of the first image;
determine a difference between the 3D model included in the second image and the 3D model included in the first image; and
identify the first set of pixels based on the determined difference.
